(19) United States
(12) Patent Application Publication
(10) Pub. No.: US 2020/0076862 A1
(43) Pub. Date: Mar. 5, 2020

(54) SYSTEMS AND METHODS FOR DISTRIBUTED REAL-TIME MULTI-PARTICIPANT CONSTRUCTION, EVOLUTION, AND APPREHENSION OF SHARED VISUAL AND COGNITIVE CONTEXT

(71) Applicant: Oblong Industries, Inc., Los Angeles, CA (US)

(72) Inventors: Eben Eliason, Los Angeles, CA (US); Kate Davies, Los Angeles, CA (US); Sean Weber, Los Angeles, CA (US); Mark Backman, Los Angeles, CA (US); Carlton J. Sparrell, Los Angeles, CA (US); John Stephen Underkoffler, Los Angeles, CA (US)

(21) Appl. No.: 16/553,016

(22) Filed: Aug. 27, 2019

Related U.S. Application Data
(60) Provisional application No. 62/723,986, filed on Aug. 28, 2018.

(51) Int. Cl. H04L 29/06; H04N 7/15; H04M 3/56; G06F 3/14; G06F 3/0489

(52) U.S. Cl. CPC H04L 65/403; H04N 7/152; H04N 7/155; G06F 2203/04803; G06F 3/1462; G06F 3/04897; H04M 3/567

(57) ABSTRACT

Systems and methods for content collaboration using context information.

### CROSS-REFERENCE TO RELATED APPLICATIONS

This application claims the benefit of U.S. Provisional Application No. 62/723,986 filed 28 Aug. 2018, which is incorporated in its entirety by this reference.

### TECHNICAL FIELD

This disclosure herein relates generally to display systems, and more specifically to new and useful systems and methods for controlling display systems by using computing devices.

### BACKGROUND

Typical display systems involve a computing device providing display output data to a display device that is coupled to the computing device. There is a need in the computing field to create new and useful systems and methods for controlling display systems by using computing devices. The disclosure herein provides such new and useful systems and methods.

### BRIEF DESCRIPTION OF THE FIGURES

FIGS. 1A-C are schematic representations of systems in accordance with embodiments.

FIG. 2 is a schematic representation of a method in accordance with embodiments.

FIGS. 3A-D are visual representations of exemplary collaboration sessions according to embodiments.

FIG. 4 is an architecture diagram of a collaboration system, in accordance with embodiments.

FIG. 5 is an architecture diagram of a collaboration device, in accordance with embodiments.

FIG. 6 is an architecture diagram of a participant system, in accordance with embodiments.

### DESCRIPTION OF EMBODIMENTS

The following description of embodiments is not intended to limit the invention to these embodiments, but rather to enable any person skilled in the art to make and use the embodiments.

### Overview

Systems and methods for collaborative computing are described herein.

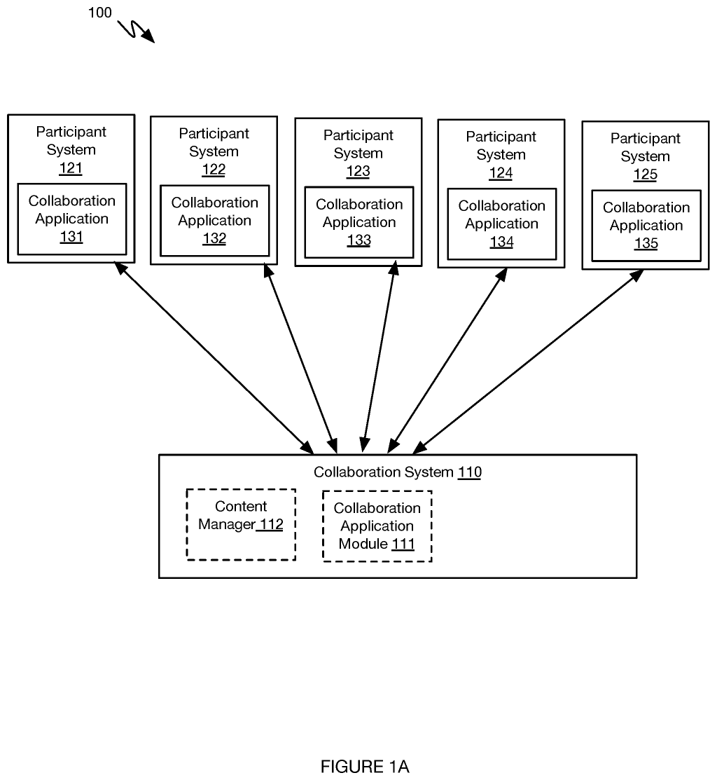

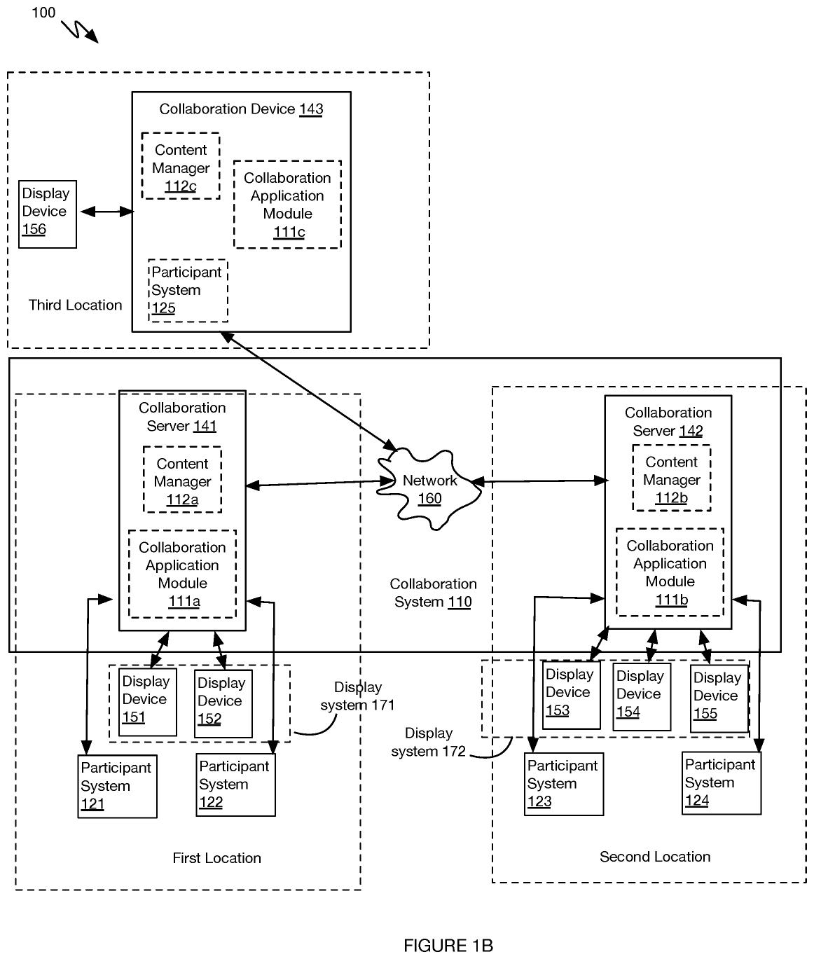

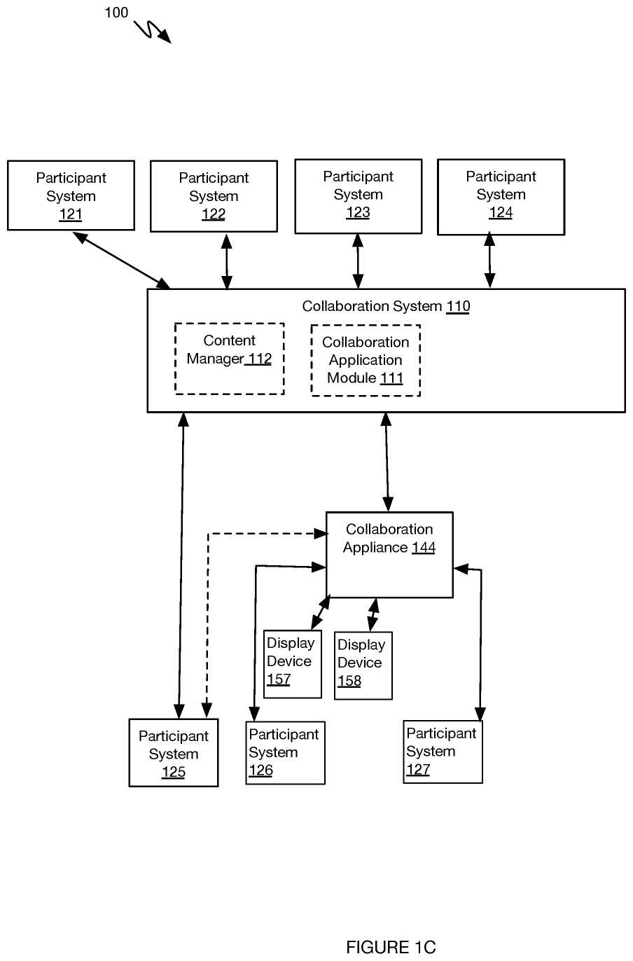

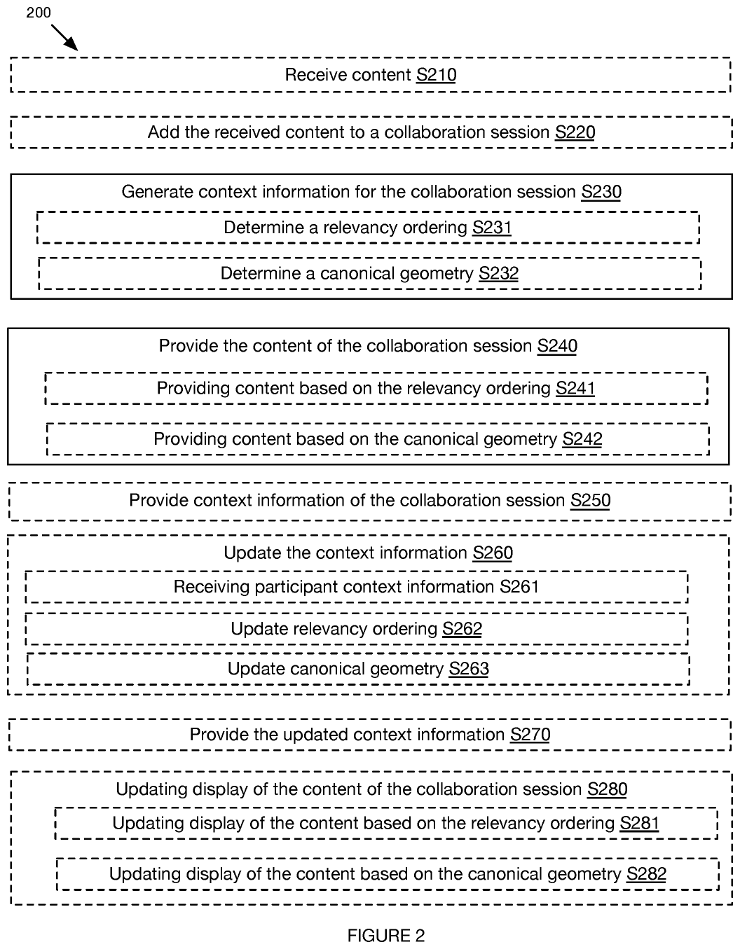

In some embodiments, the system includes at least one collaboration system (e.g., 110 shown in FIGS. 1A-C).

In some embodiments, at least one collaboration system of the system (e.g., 110 shown in FIGS. 1A-C) receives content elements from a plurality of content sources. In some embodiments, content sources include computing devices (e.g., on-premises collaboration appliances, mobile computing devices, computers, etc.) In some embodiments, the received content elements include a plurality of content streams. In some embodiments, each content element is associated with at least one of a person and a location. In some embodiments, at least one collaboration server of the system adds the content elements received from a plurality of content sources to a collaboration session. In some embodiments, at least one participant system establishes a communication session with the collaboration server, wherein the participant system adds at least one content element to the collaboration session and receives content elements added to the collaboration session, via the established communication session.

In some embodiments, the content elements received from the plurality of content sources includes at least one of static digital elements (e.g., fixed data, images, and documents, etc.), and dynamic digital streams (e.g., live applications, interactive data views, entire visual-GUI environments, etc.). In some embodiments, the content elements received from the plurality of content sources includes live video streams, of which examples include whiteboard surfaces and audio and video of human participants. In some embodiments, at least one of the plurality of content sources is participating in a collaboration session managed by the collaboration system.

In some embodiments, at least one content element is a content stream. In some embodiments, each received content element is a content stream. In some embodiments, the received content elements include a plurality of content streams received from at least one computing device. In some embodiments, the collaboration server receives at least a video content stream and a screen sharing content stream from at least one computing device. In some embodiments, the collaboration server receives at least a video content stream and a screen sharing content stream from a plurality of computing devices. In some embodiments, the collaboration server receives at least an audio content stream and a screen sharing content stream from a plurality of computing devices.

In some embodiments, the collaboration server functions to provide content of a collaboration session to all participant systems (e.g., 121-125 shown in FIGS. 1A-C) participating in the collaboration session.

In some embodiments, the collaboration server functions to uniformly expose participants of a collaboration session to time-varying context of the collaboration session, and to insure that all participants' understanding of that context is closely synchronized.

In some embodiments, a collaboration session's primary context is a cognitive synthesis of (1) static and stream content, including interaction with and manipulation of individual streams; (2) verbal and other human-level interaction among the participants; and (3) the specific moment-to-moment geometric arrangement of multiple pieces of content across the system's displays (e.g., displays of devices 131d, 132d, 133d, 131e, 132e, and displays 114e). In some embodiments, secondary context includes awareness of participant identity, location, and activity; causal linkage between participants and changes to content streams and other elements of a collaboration session's state; and ‘derived’ quantities such as inferred attention of participant subsets to particular content streams or geometric regions in the layout.

In some embodiments, at least one participant in a session operates in a particular location (e.g., “first location”, “second location”, and “third location” shown in FIG. 1B). In some embodiments, at least one participant subscribes to a specific display geometry. In some embodiments, at least one location includes a room (e.g., “first location” shown in FIG. 1B), in which the geometry is defined by a set of fixed screens (e.g., 151, 152) attached to the wall or walls and driven by dedicated hardware (e.g., embedded computing systems, collaboration server 141, etc.). In some locations, the display is a display included in a participant's personal computing device (e.g., a display of devices 121-125). In some embodiments, the collaboration session is a virtual collaboration session that does not include conference room display screens. In some embodiments, all participants interact via a participant device (e.g., a personal computing device), and each participant perceives content of the session via a display device included in their participant device.

In some embodiments, at least a portion of the processes performed by the system are performed by at least one collaboration system of the system (e.g., 110). In some embodiments, at least a portion of the processes performed by the system are performed by at least one participant system (e.g., 121-127). In some embodiments, at least a portion of the processes performed by the system are performed by at least one collaboration application (e.g., 131-135 shown in FIG. 1A) included in a participant system. In some embodiments, at least a portion of the processes performed by the system are performed by at least one display device (e.g., 151-158). In some embodiments, at least a portion of the processes performed by the system are performed by at least one of a collaboration application module (e.g., 111 shown in FIG. 1A, 111a-c shown in FIG. 1B), a content manger (e.g., 112 shown in FIG. 1A, 112a-c shown in FIG. 1C), and a collaboration server (e.g., 141, 142 shown in FIG. 1B, 144 shown in FIG. 1C). In some embodiments, at least a portion of the processes performed by the system are performed by a collaboration device (e.g., 143 shown in FIG. 1B).

In some embodiments, the system allows any participant to inject content into the collaboration session at any time. In some embodiments, the system further provides for any participant to instantiate content onto and remove content from display surfaces, and to manipulate and arrange content on and among display surfaces once instantiated. In some embodiments, the system does not enforce serialization of such activity; multiple participants may manipulate the session's state simultaneously. Similarly, in some embodiments, these activities are permitted irrespective of any participant's location, so that all interaction is parallelized in both space and time. In some embodiments, the content and geometry control actions are enacted via participant systems (e.g., laptops, tablets, smartphones, etc.) or via specialized control devices (e.g., spatial pointing wands, etc.). The system also allows non-human participants (e.g., cognitive agents) to inject content into the collaboration session at any time, either in response to external data (e.g. alerts, observations, or triggers) or based on analysis of internal meeting dynamics (e.g. verbal cues, video recognition, or data within the content streams).

In some embodiments, the system recognizes that a collaboration session may be distributed among participants in a variety of locations, and that the display geometries in those locations are in general heterogeneous (as to number, orientation, and geometric arrangement of displays). In some embodiments, the system functions to ensure that each participant perceives the same content at the same time in the same manner. In some embodiments, the system functions to distribute all content in real time to every participating location. In a first mode, the system synchronizes the instantaneous layout of content at each location, employing special strategies to do so in the presence of differing display geometries. In some embodiments, a canonical content layout is represented by a session-wide ‘Platonic’ display geometry, agreed to by all locations and participating systems. An individual location may then render the session's instantaneous state as an interpretation of this canonical content layout. All interactions with the system that affect the presence, size, position, and arrangement of visible elements directly modify the underlying canonical layout.

In some embodiments, participants may elect to engage other viewing-and-interaction modes not based on a literal rendering of this underlying layout model—for example, a mode that enables inspection of one privileged piece of content at a time—but manipulations undertaken in these modes still modify the canonical layout.

In some embodiments, the collaboration session is a virtual collaboration session that does not include conference room display screens. In some embodiments, the collaboration session is a virtual collaboration session that does not include conference room display screens, and there is a canonical layout but there is no canonical geometry. In some embodiments, the canonical layout is a layout of content elements of the collaboration session. In some embodiments, the canonical layout is a canvas layout of the content elements of the collaboration session within a canvas. In some embodiments, the collaboration session is a virtual collaboration session that does not include conference room display screens, and there is no canonical layout or canonical geometry.

Users of the system may be few or many, local or remote, alone or in groups. The system can provide an experience for all users regardless of their location, circumstances, device(s), or display geometry. In some embodiments, the system captures the identity of all participants in the session, allowing it to associate that identity with actions they take and items they view, and to provide useful context to others both regarding who content belongs to, as well as who can see that content.

In some embodiments, participant systems provide any manner of input capabilities through which users may interact with the system; they may provide one or more streams of content, either stored on them, accessible through them, or produced by them; and most will be associated with one or more displays upon which the shared information will be rendered.

In some embodiments, the system functions to provide real-time sharing of parallel streams of information, often live but sometimes static, amongst all participants. The type and other properties of the content streams may affect their handling within the system, including their methods of transport, relevance in certain contexts, and the manner in which they are displayed (or whether they are displayed at all). Specific types of streams, such as the live audio and/or video of one or more participants, or a live stream of an whiteboard surface, may receive privileged treatment within the system. In some implementations, the whiteboard surface is an analog whiteboard surface. In some implementations, the whiteboard surface is a digital whiteboard surface.

In some embodiments, the system invites participants to introduce content streams to it or remove content streams from it at any time by using participant systems. One or more streams may be contributed to the system by any given participant system, and any number of participants or devices may contribute content streams in parallel. Although practical limits may exist, there is no theoretical limit on the number of participants, devices, or content streams the system is capable of handling.

In some embodiments, each participant in a collaboration session will have access to a particular display geometry, driven by one or more devices at their location, and upon which a visual representation of the shared context and the content streams of the collaboration session are presented. These display geometries, like the devices themselves, may be personal or shared.

In some embodiments, shared displays (e.g., 114c) may be situated in conference rooms, including traditional video teleconferencing systems or display walls composed of two or more screens, generally of ample size and resolution, mounted on the wall (or walls) of a shared space. In some embodiments, the collaboration session is a collaboration session that does not include conference room display screens, and display screens included in participant devices function as shared displays for the conference room; and content of the collaboration session is displayed by the display screens of the participant devices as if the displays were conference room displays. In some embodiments, the collaboration session is a conference room collaboration session, display screens of participant devices present in the conference room function as conference room display screens, and content of the collaboration session is displayed across at least some of the participant device display screens in the conference room. In some embodiments, at least one participant device located in a conference room functions as collaboration system (or a collaboration server).

In some embodiments, the system functions to enable sharing of spatial context of collaboration session content displayed in a conference room across multiple displays. In some embodiments, a canonical geometry is defined for the purposes of representing the relative locations of content within the system, as agreed to among and optimized for all participants according to their individual display geometries. In some embodiments, the canonical layout of content streams of a collaboration session is then determined with respect to this shared geometry, and mapped back onto the display geometries of individual participants and locations.

In some embodiments, the display geometries considered by this system are capable of displaying many pieces of content at once. To assist participants in managing this visual complexity, the system attempts to understand where the attention of the group lies, to communicate areas of attention, and to infer the most relevant item of focus.

In some embodiments, attention is directed explicitly through pointing, annotation, or direct action on the content streams; or it may be implicit, inferred from contextual clues such as the relative size, position, or ordering of those streams. Depending on their display geometry, participants may have, or may choose to assume, direct control of the content stream or streams they wish to focus on. In aggregate, this information allows the system to know who is looking at what, and how many are looking at a given content stream.

In some embodiments, the system functions to both infer and to visually depict attention in order to provide helpful context to the distributed participants. In some embodiments, attention represents a spectrum. A shared content stream might have no viewers, some viewers, or many. Focus, by contrast, denotes a singular item of most relevance—at one extreme of the attention spectrum. These ideas, though related, represent distinct opportunities to communicate the relative importance of the many streams of content present in the system.

In some embodiments, in an effort to assist users in their shared understanding of the context of a collaboration session (e.g., provided by a collaboration system, such as 110 shown in FIGS. 1A-C), the system defines an ordering of all content streams, which is taken as part of the shared context. In some implementations, this ordering takes the form of a singular stack that can be thought of as representing the spectrum of attention, from bottom to top, with the topmost item being that of immediate focus. The spatial relationships between streams, the attention of the participants, and the actions participants take within the system combine to determine the momentary relevance of a given content stream.

In some embodiments, content streams are pushed onto the relevancy stack as they appear, and are popped off or removed from the relevancy stack when they disappear. Both the actions of participants and decisions made by the system in response to these actions, or to other inputs, impact the ordering of items within the relevancy stack and therefore the shared understanding of their relative importance.

In some embodiments, visibility of a content element included in the collaboration session is used to determine the relevance of the content element. In some embodiments, although the collection of content (e.g., content streams) shared within the system is part of the shared context, only those which are presently visible in the canonical layout defined by the shared geometry are considered to have any relevance to the group. In such embodiments, any action which adds a content stream to the canonical layout, or which through reordering, scaling, or other action makes it visible, causes that stream to be added to the relevancy stack. Conversely, any action which removes a stream from the canonical layout, or which through reordering, scaling, or other action makes it invisible, causes that stream to be removed from the relevancy stack.

In some embodiments, the system functions to identify contextual cues, both explicit and implicit, regarding the relative importance of visible content streams in the canonical layout defined by the shared geometry. These cues fall into two categories: promotional cues, and demotional cues.

As their name suggests, promotional cues increase the relative importance of a given content stream. Depending on the circumstances, these cues may move a content stream to a higher position in the stack, or—in some cases—pull it directly to the top of the stack. This results from the fact that many actions imply an immediate shift of focus, and thus a new most-relevant item within the shared context.

By contrast, demotional cues decrease the relative importance of a given content stream. Depending on the circumstances, these cues may move a content stream to a lower position in the stack, or—in some cases—push it directly to the bottom of the stack. This results from the fact that some actions imply an immediate loss of focus. In some implementations, when the topmost item in the stack gets demoted, the new topmost item—the next most relevant—becomes the new focus.

In some embodiments, content element properties that provide contextual cues (e.g., promotional, demotional cues) include properties identifying at least one of: time of addition of the content element to the collaboration session; size of the content element; occlusion; order of the content element among the content elements included in the session; content type; interaction with the content element; pointing at the content element; annotation on the content element; number of participants viewing the content element; identities of viewers viewing the content element; selection of the content element as a focus of the collaboration session; participant sentiment data associated with the content element; and participant reaction data associated with the content element. In some embodiments, sentiment data relates to non-verbal sentiment (e.g., emojis). In some embodiments, reaction data relates to non-verbal reaction (e.g., emojis).

In some embodiments, content element properties that provide contextual cues (e.g., promotional, demotional cues) include at least one of the properties shown below in Table 1.

TABLE 1

| | |
|---|---|
| Newness | How recently a content element was added to the canonical layout |
| | suggests a relative importance. More recently added items are assumed |
| | to be more temporally relevant. |
| Size | The relative size of content elements communicates information about |
| | their relative importance, with larger content elements having more |
| | relevance. Content elements scaled to a “full screen” size may have |
| | additional significance. |
| Occlusion | The less of a content element that is visible, the lower its relevance. In |
| | some embodiments, the system imposes a visibility threshold, such that |
| | content elements occluded by more than some percentage are considered |
| | invisible, and thus irrelevant. |
| Ordering | In some embodiments, the ordering and/or stacking, of content elements |
| | within a displayed canvas implies an ordering of relevance. |
| Content Type | Certain types of content may be inherently more relevant. For instance, |
| | live content streams may be more relevant than static ones; live streams |
| | with higher levels of temporal change may be more relevant than those |
| | with lower levels of change. Furthermore, specific types of content, such |
| | as the video chat feed, may have greater, or privileged, relevance. |
| Interaction With | Interaction with a given content element suggests immediate relevance. |
| | For instance: advancing the slides of a presentation, turning the pages of |
| | a PDF, navigating to a new page in a web browser, and entering text into |
| | a document all indicate relevance, as it can be presumed that these |
| | actions are being taken with the intent of communicating information to |
| | the other participants. |
| Pointing At | The act of pointing represents a strong indication of relevance. Pointing |
| | is a very natural human gesture, and one which is well established in |
| | contexts of both presentation and visual collaboration. Pointing cues |
| | may come from any participant regardless of location and input device, |
| | be they from a mouse, a laser pointer or other pointing implement, or |
| | even from the physical gestures of participants as interpreted by |
| | computer vision software. |
| Annotation On | As an extension of pointing, marking up or annotating atop a content |
| | element serves as an indication of relevance. These actions represent an |
| | explicit attempt to call attention to specific regions of the layout, streams |
| | of content, or details within them. |
| Attention | Though many of the above cues have implications of attention or focus, |
| | attention can be measured in certain views in order to have a better |
| | understanding of the aggregate attention of the group. Specifically, a |
| | number of viewers of a given content element, the moving average |
| | viewing duration, or the specific identity of viewers can be determined |
| | to make decisions about relevance. For instance, content streams with |
| | more viewers may be assumed to have more relevance. |
| Explicit Intent | The system may also expose mechanisms through which users may |
| | expressly denote a particular content element as the current focus. This |
| | might take the form of a momentary action, such as a button which calls |
| | focus to a specific content element like a shared screen, or an ongoing |
| | effect, such as in a “follow the leader” mode where an individual |
| | participant's actions (and only those actions) direct the focus of the |
| | group. |
| Cognitive Agents | Events triggered by cognitive agents participating in the shared context |
| | may promote or demote particular content elements; add, move, or |
| | rearrange content elements; or suggest a change of focus. An agent |
| | monitoring external data, for example, may choose through some |
| | analysis of that data to present a report of its current state; or, an agent |
| | monitoring the discussion may introduce or bring to the forefront a |
| | content element or content elements containing related information. |

In some embodiments, display geometries of participants or groups of participants may vary greatly in size, resolution, and number of screens. While elements of the shared context are globally observed, the display geometry of some participants may not afford accurate or complete representations of that information. Therefore, in some embodiments, two viewing modes are provided for the shared context such that the most important aspects of the information are accessible to participants as needed. In some embodiments, a plurality of viewing modes are provided, whereas in other embodiments, only a single viewing mode is provided.

In a first viewing mode (Room View), geometric accuracy and the spatial relationships between discrete content streams are emphasized. In a second viewing mode (Focus View) an individual stream of content is emphasized, providing a view that maximizes the fidelity of the viewing experience of that content, making it a singular focus. By virtue of providing these two viewing modes, embodiments enable a range of viewing experiences across many possible display geometries, regardless of size and resolution.

In some embodiments, Room View prioritizes a literal representation of the visible content elements present in the shared context of the collaboration session, preserving spatial relationships among them. It portrays all content as it is positioned in the canonical layout with respect to the shared geometry, including the depiction of individual screens. As a certain degree of homogeneity of display geometries across locations may be assumed, this view often reflects a true-to-life representation of the specific physical arrangement of both the content on the screens as well as the screens themselves within one or more conference rooms participating in the session.

In some embodiments, Room View exposes the spatial relationships between content that participants having larger display geometries are privileged to see at scale, even when the display geometry of the viewer may consist of a single screen. It presents a view of the world from the outside in, ensuring that the full breadth of the visible content can be seen, complete with the meta information described by its arrangement, ordering, size, and other spatial properties. Room View is useful for the comparison, juxtaposition, sequencing, and grouping of content.

In some embodiments, actions taken within Room View are absolute. Manipulations of content elements such as moving and scaling impart immediate changes on the shared context (of the collaboration session), and thus are reflected in all display geometries currently expressing the geometric components of the shared context. These actions serve as explicit relevancy cues within the system.

In some embodiments, Focus View prioritizes viewing of a singular content element of immediate relevance. In contrast to Room View, Focus View provides no absolute spatial representation of any kind. It is relative; it is abstract. Focus View represents the relevance of the collection of content elements rather than their positions. Focus View embodies focus, and a depth of concentration on and interaction with a singular content element.

In some embodiments, with its singular focus and emphasis on maximizing the view of a sole content element, Focus View provides a representation of the shared context optimized for smaller display geometries, including those with a single screen. Within this context, viewers may elect which particular content element to focus on; or, they may opt instead to entrust this choice to the system, which can adjust the focus on their behalf in accordance with the inferred attention and focus of the participants of the collaboration session. In some implementations, the boundary between these active and passive modes of interaction is deliberately thin, allowing viewers to transition back and forth between them as needed.

In some embodiments, actions taken within Focus View do not represent explicit changes to the shared context. In some implementations, selection of a content element to focus and the transition between active and passive viewing modes has an indirect effect on the shared context (of the collaboration session) by serving as a signifier of attention. In some implementations, the aggregate information from many participants provides information about the overall relevance of the available content.

In some embodiments, the collaboration session is a virtual collaboration session that does not include conference room display screens, and there is no canonical layout or canonical geometry. In some embodiments, for virtual collaboration sessions that do not include conference room display screens, only Focus View is provided.

In a distributed context, collective attention may not be easily inferred by participants. However, in some embodiments, the system collects aggregate knowledge regarding the attention of participants, based both on the content elements they choose to view, as well as their interactions with the system. Depicting the attention of other participants, and the inferred focus of the participants, can help guide participants to the most relevant content elements as they change over time through the course of the collaboration session.

In some embodiments, the system depicts attention at various levels of detail, such as by indicating a general region of the shared geometry, a particular content element within it, or a specific detail within a given content element. For instance, attention might be focused on the leftmost screen, which might have one or more content elements present upon it; or, attention might be focused on an individual content element, such as the newly shared screen of a participant; or a participant might have chosen to zoom into a particular portion of a high resolution static graphic, indicating a high level attention in a much more precise area.

In some embodiments, the specificity with which attention is communicated may also vary, according to its level of detail, the size of the shared geometry, the time or circumstances in which it is communicated, or other factors. For instance, attention could be communicated generally by indicating the regions or content elements which are currently visible to one or more of the other participants (or, by contrast, those which are not visible to any). In some implementations, the system identifies for at least one content element of the collaboration session, a number of participants that have given the content element their attention. In some implementations, the system identifies for at least one content element of the collaboration session, identities of participants that have given the content element their attention.

In some embodiments, because the relevancy stack defines a canonical relevancy ordering for all visible content elements in the layout, it is also possible to depict the current focus according to the shared context. This focus may be depicted continuously, as a persistent signifier of the focus of the participants as interpreted by the system; or, it may be depicted transiently, as a visual cue that attention has shifted from one region or content stream to another.

In some embodiments, the system functions to allow participants to transition back and forth between Room View and Focus View easily, providing the freedom to depict the shared context of a collaboration session in a manner most appropriate to a participant's local display geometry or the immediate context of the session—say, if needing to compare two items side by side even when participating on a laptop with a single display.

However, the information presented in each of these views is not mutually exclusive. In some embodiments, content elements visible within the canonical layout remain present in both Room View and Focus View. In some embodiments, transition between Room View and Focus View is animated seamlessly in order to emphasize this continuity, and to assist participants in understanding the relationship between the portions of the shared context presented in each view.

By virtue of the forgoing, embodiments herein enable geographically distributed participants to work together more effectively through the high capacity exchange of visual information. Embodiments facilitates this exchange through the parallelized distribution of many content elements (e.g., streams), both from individual participants and other shared sources, and by maintaining a shared global context for a collaboration session, including information about its participants, the shared content streams, and a canonical layout with respect to a shared geometry that describes what its participants see.

Embodiments affords users a high level of control, both over the visibility, size, position, and arrangement of the content elements in the canonical layout, as well as over the manner in which that content is displayed on the local display(s). At the same time, embodiments observe the actions of its participants, their view into the shared context, and properties of that context or the content elements within it in order to make inferences regarding the relevancy of individual streams of content and the attention of the session's participants.

Embodiments mediate the experience of the session's participants by making choices on their behalf based on its understanding of the shared context and the attention of the group. By depicting its understanding of group attention and focus, embodiments exposes useful context that may otherwise be difficult for individuals to infer in a distributed meeting context. These cues can assist participants, especially those who are remote, in following the shifting context of the session over time. Participants may even elect to remain passive, allowing the system to surface the most relevant content automatically.

Embodiments also invite active engagement, allowing participants of a collaboration session to take actions that redirect attention, explicitly or implicitly shifting the focus to something new. This give and take between the human and the digital creates a feedback loop that carries the shared context forward. Regardless of which side asserts control over the shared context, the views into that context provided by the system ensure that all participants maintain a synchronized understanding of the content being shared.

Embodiments remove bottlenecks, enabling information to flow freely among all participants in a collaboration session, providing a new approach to sharing and viewing multiple streams of content across distance, while ensuring that a shared understanding of focus is maintained.

### Systems

In some embodiments, the system 100 includes at least one collaboration system 110 and at least one participant system (e.g. device) (e.g., 121-125).

In some embodiments, the method disclosed is performed by the system 100 shown in FIG. 1A. In some embodiments, the method disclosed is performed at least in part by at least one collaboration system (e.g., 110). In some embodiments, the method disclosed is performed at least in part by at least one participant system (e.g., 121-127).

In some embodiments, at least one collaboration system (e.g., 110) functions to manage at least one collaboration session for one or more participants. In some embodiments, the collaboration system includes one or more of a CPU, a display device, a memory, a storage device, an audible output device, an input device, an output device, and a communication interface. In some embodiments, one or more components included in the collaboration system are communicatively coupled via a bus. In some embodiments, one or more components included in the collaboration system are communicatively coupled to an external system via the communication interface.

The communication interface functions to communicate data between the collaboration system and another device (e.g., a participant system 121-127). In some embodiments, the communication interface is a wireless interface (e.g., Bluetooth). In some embodiments, the communication interface is a wired interface. In some embodiments, the communication interface is a Bluetooth radio.

The input device functions to receive user input. In some embodiments, the input device includes at least one of buttons and a touch screen input device (e.g., a capacitive touch input device).

In some embodiments, the collaboration system includes one or more of a collaboration application module (e.g., 111 shown in FIG. 1A, 111a-c, shown in FIG. 1B) and a content manager (e.g., 112 shown in FIG. 1A, 112a-c shown in FIG. 1C). In some embodiments, the collaboration application module (e.g., 111) functions to receive collaboration input from one or more collaboration applications (e.g., 131-135) (running on participant systems), and provide each collaboration application of a collaboration session with initial and updated collaboration session state information of the collaboration session. In some embodiments, the collaboration application module (e.g., 111) manages session state information for each collaboration session. In some embodiments, the content manager (e.g., 112) functions to manage content elements (e.g., provided by a collaboration application, stored at the collaboration system, stored at a remote content storage system, provided by a remote content streaming system, etc.). In some embodiments, the content manager (e.g., 112) provides content elements for one or more collaboration sessions. In some embodiments, the content manager functions as a central repository for content element and/or related attributes for all collaboration sessions managed by the collaboration system (e.g., 110).

In some embodiments, each participant system (e.g., 121-125) functions to execute machine-readable instructions of a collaboration application (e.g., 131-135). Participant systems can include one or more of a mobile computing device (e.g., laptop, phone, tablet, wearable device), a desktop computer, a computing appliance (e.g., set top box, media server, smart-home server, telepresence server, local collaboration server, etc.), a vehicle computing system (e.g., an automotive media server, an in-flight media server of an airplane, etc.). In some embodiments, at least one participant system includes one or more of a camera, an accelerometer, an Inertial Measurement Unit (IMU), an image processor, an infrared (IR) filter, a CPU, a display device, a memory, a storage device, an audible output device, an audio sensing device, a haptic feedback device, sensors, a GPS device, a WiFi device, a biometric scanning device, an input device. In some embodiments, one or more components included in a participant system are communicatively coupled via a bus. In some embodiments, one or more components included in a participant system are communicatively coupled to an external system via the communication interface of the participant system. In some embodiments, the collaboration system (e.g., 110) is communicatively coupled to at least one participant system (e.g., via a public network, via a local network, etc.). In some embodiments, the storage device of a participant system includes the machine-readable instructions of a collaboration application (e.g., 131-135). In some embodiments, the collaboration application is a stand-alone application. In some embodiments, the collaboration application is a browser plug-in. In some embodiments, the collaboration application is a web application. In some embodiments, the collaboration application is a web application that is executed within a web browser, and that is implemented using web technologies (e.g., HTML, JavaScript, etc.).

In some embodiments, the collaboration application (e.g., 131-135) includes one or more of a content module and a collaboration module. In some embodiments, each module of the collaboration application is a set of machine-readable instructions executable by a processor of the corresponding participant to perform processing of the respective module.

In some embodiments, at least one collaboration system (e.g., 110) is a cloud-based collaboration system.

In some embodiments, at least one collaboration system (e.g., 110) is an on-premises collaboration device (appliance).

In some embodiments, at least one collaboration system (e.g., 110) is a peer-to-peer collaboration system that includes a plurality of collaboration servers (e.g, 141, 142) that communicate via peer-to-peer communication sessions. In some implementations, each collaboration server of the peer-to-peer collaboration system includes at least one of a content manager (e.g., 112a-c) and a collaboration application module (e.g., 111a-c). In some implementations, at least one collaboration server (e.g., 144, 142) is implemented as an on-premises appliance that is communicatively coupled to at least one display device (e.g., 151, 152) and at least one participant system (e.g, 121, 122). In some implementations, at least one collaboration server (e.g., 143) is implemented as a remote collaboration device (e.g., a computing device, mobile device, laptop, phone, etc.) that communicates with other remote collaboration devices or other collaboration servers via at least one peer-to-peer communication session. FIG. 1B shows a peer-to-peer collaboration system 110 that includes two collaboration servers, 141 and 142 that communicate via a peer-to-peer communication session via the network 160. Remote collaboration device 143 also communicates with collaboration servers 141 and 142 via peer-to-peer communication sessions via the network 160.

In some embodiments, the system 100 includes at least one cloud-based collaboration system (e.g., 110) and at least one on-premises collaboration appliance (e.g., 144). FIG. 1C shows a cloud-based collaboration system 110 that is communicatively coupled to an on-premises collaboration appliance 144.

In some embodiments at least one collaboration server (e.g., 141, 142, 144) is communicatively coupled to at least one of a computational device (e.g., 121-125) (e.g., a mobile computing device, a computer, a user input device, etc.), a control device (e.g., a mobile computing device, a computer, a user input device, a control device, a spatial pointing wand, etc.), and a display (e.g., 151-155) (via at least one of a public network, e.g., the Internet, and a private network, e.g., a local area network). For example, a cloud-based collaboration system 110 can be communicatively coupled to an on-premises collaboration appliance (e.g., 144) via the Internet, and one or more display devices (e.g., 157, 158) and participant systems (e.g., 126, 127) can be communicatively coupled to the on-premises collaboration appliance 144 via a local network (e.g., provided by a WiFi router) (e.g., as shown in FIG. 1C).

In some embodiments, the collaboration system 110 is a Mezzanine® collaboration system provided by Oblong Industries®. In some embodiments, at least one of the collaboration servers 141, 142 and 144 are Mezzanine® collaboration servers provided by Oblong Industries®. However, any suitable type of collaboration server or system can be used.

FIG. 1B shows a collaboration system 110 that includes at least a first collaboration server 141 communicatively coupled to a first display system (that includes display devices 151 and 152) and a second collaboration server 142 communicatively coupled to a second display system (that includes display devices 153-155), wherein the first display system is at a first location and the second display system is at a second location that is remote with respect to the first location. In some embodiments, the first collaboration server 141 is communicatively coupled to at least one participant system (e.g., 121, 122) via one of a wireless and a wired interface. In some embodiments, the second collaboration server 142 is communicatively coupled to at least one participant system (e.g., 123, 124). In some embodiments, the first display system includes a plurality of display devices. In some embodiments, the first and second collaboration servers include collaboration application modules 111a and 111b, respectively. In some embodiments, the collaboration application modules are Mezzanine collaboration application modules. In some embodiments, the first collaboration server 141 is communicatively coupled to the second collaboration server 142. In some embodiments, the first display system includes a plurality of display devices. In some embodiments, the second display system includes a plurality of display devices. In some embodiments, the first display system includes fewer display devices than the second display system.

As shown in FIG. 1B, in some embodiments, a remote collaboration client device 143 (e.g., a laptop, desktop, mobile device, tablet, and the like) located in a third location is communicatively coupled to at least one of the collaboration server 141 and 142. In some embodiments, the remote collaboration client device 143 includes a display device 156. In some embodiments, the remote collaboration client device 143 is communicatively coupled to a display device (e.g, an external monitor). In some embodiments, the remote collaboration client device 143 includes a remote collaboration application module 111c. In some embodiments, the remote collaboration application module (e.g., 111c) is a Mezzanine remote collaboration application module. In some embodiments, at least one of the collaboration application modules (e.g., 111a-c) is a Mezzanine remote collaboration application module. However, the application modules 111a-c can be any suitable type of collaboration application modules.

In some embodiments, at least one collaboration application module (e.g., 111, 111a-c) includes machine-executable program instructions that when executed control the respective device (e.g., collaboration system 110 shown in FIG. 1A, collaboration server 141-142, collaboration device 143) to display parallel streams of content (of a collaboration session) in real-time, synchronized coordination, as described herein.

In some embodiments, the collaboration application module 111 (e.g., shown in FIG. 1A) includes machine-executable program instructions that when executed control at least one component of the collaboration system 110 (shown in FIGS. 1A and 1C) to provide parallel streams of content (of a collaboration session) in real-time, synchronized coordination to each participant system (e.g., 121-125) of a collaboration session. In some embodiments, the collaboration application module 111 includes machine-executable program instructions that when executed control at least one component of the collaboration system 110 (shown in FIGS. 1A and 1C) to provide parallel streams of content (of a collaboration session) in real-time, synchronized coordination to each participant system (e.g., 121-125) of a collaboration session, and to each collaboration appliance participating in the collaboration session (e.g., 144). In some embodiments, a collaboration appliance (e.g., 144) functions as a participant device by communicating with a cloud-based collaboration system 110, and functions as an interface to allow participant systems directly coupled to the appliance 144 to participate in a session hosted by the cloud-based collaboration system 110, by forwarding data received from participant system (e.g., 126, 127) to the collaboration system 110, and displaying data received form the collaboration system 110 at display devices coupled to the appliance (e.g., 157, 158).

In some embodiments, at least one remote collaboration application module (e.g., 111c shown in FIG. 1B) includes machine-executable program instructions that when executed control the respective remote collaboration client device (e.g., 143) to display parallel streams of content (of a collaboration session) by using the respective display system (e.g., 156) in real-time, synchronized coordination with at least one of a collaboration server (e.g., 141, 142) and another remote collaboration client device that is participating in the collaboration session, as described herein.

In some embodiments, at least one collaboration application module (e.g., 111, 111a-c) includes machine-executable program instructions that when executed control the respective collaboration server to store and manage a relevancy stack, as described herein. In some embodiments, the remote collaboration application module includes machine-executable program instructions that when executed control the remote collaboration client device to store and manage a relevancy stack, as described herein. In some embodiments, each collaboration application module includes machine-executable program instructions that when executed control the respective collaboration server to synchronize storage and management of the relevancy stack, as described herein. In some embodiments, each remote collaboration application module includes machine-executable program instructions that when executed control the respective remote collaboration client device to synchronize storage and management of the relevancy stack with other collaboration application modules (e.g., of remote collaboration client devices, of remote collaboration servers), as described herein.

### Method

In some embodiments, the method 200 is performed by a at least one component of the system described herein (e.g., 100). In some embodiments, the method 200 is performed by a collaboration system (e.g., 110 of FIGS. 1A-C). In some embodiments, at least a portion of the method 200 is performed by a collaboration system (e.g., 110 of FIGS. 1A-C). In some embodiments, at least a portion of the method 200 is performed by a participant device (e.g., 121-125). In some embodiments, at least a portion of the method 200 is performed by a collaboration server (e.g., 141, 142, 144). In some embodiments, at least a portion of the method 200 is performed by a collaboration device (e.g., 143).

In some embodiments, the method 200 includes at least one of: receiving content S210; adding the received content to a collaboration session S220; generating context information that identifies context of the collaboration session S230; providing the content of the collaboration session S240; providing the context information S250; updating the context information S260; providing the updated context information; and updating display of the content of the collaboration session S280.

In some implementations of cloud-based systems, the collaboration system 110 performs at least a portion of one of processes S210-S270, and optionally S280. In some implementations of peer-to-peer systems, the multiple collaboration servers (e.g., 141-143) coordinate processing to perform at least a portion of one of processes S210-S270, and optionally S280.

S210 functions to receive content elements from a plurality of content sources (e.g., participant devices 121-125, collaboration appliance 144, etc.).

S220 functions to add the received content elements to a collaboration session. In some embodiments, each content element received at S210 is received via a communication session established for the collaboration session, and the received content elements are added to the collaboration session related to the communication session. In some embodiments, a collaboration system (e.g., 110) performs S220.

S230 functions to generate context information for the collaboration session. In some embodiments, S230 includes determining a relevancy ordering S231. In some embodiments, the collaboration system 110 manages a relevancy stack that identifies the relevancy ordering of all content elements of the collaboration session, and updates the relevancy ordering in response to contextual cues. In some embodiments, contextual cues include at least one of explicit cues and implicit cues, regarding the relative importance of visible content elements in a layout (e.g., a canonical layout). In some embodiments, contextual cues include at least one of promotional cues, and demotional cues.

In some embodiments, S230 includes determining relevancy for at least one content element of the collaboration session based on at least one of: visibility of the content element; time of addition of the content element to the collaboration session; size of the content element; occlusion of the content element; order of the content element among the content elements included in the collaboration session; content type of the content element; interaction with the content element; pointing at the content element; annotation on the content element; number of participants viewing the content element; identities of viewers viewing the content element; selection of the content element as a focus of the collaboration session; participant sentiment data associated with the content element; and participant reaction data associated with the content element. In some embodiments, S230 includes determining relative relevancy for at least one content element of the collaboration session based on at least one of collaboration input and participant context information received for the collaboration session. In some implementations, collaboration input for a collaboration session is received from at least one participant device (e.g., 121-125). In some implementations, collaboration input for a collaboration session is received from at least one specialized control device (e.g., a spatial pointing wand, etc.).

In some implementations, collaboration input identifies at least one of: view selection of at least one participant; an update of a content element attribute; content arrangement input that specifies a visible arrangement of content elements within the collaboration session; focus selection of a content element for at least one participant; cursor input of at least one participant; a preview request provided by at least one participant; a view request provided by at least one participant; a request to remove at least one content element from a visible display area; a request to add content to the collaboration session; a screen share request; annotation of at least one content element; reaction of at least one participant related to at least one content element; emotion of at least one participant related to at least one content element; a follow request to follow a focus of an identified user.

In some embodiments, S230 includes generating a canonical geometry for the collaboration session S232.

In some embodiments, the generated context information identifies at least one of the following: canvas layout of the content elements of the collaboration session within a canvas; the canonical geometry for the collaboration session; visibility of at least one content element; time of addition of at least one content element to the collaboration session; size of at least one content element; occlusion of at least one content element; order of the content elements among the content elements included in the collaboration session; content type of at least one content element; interaction with at least one content element; pointing information related to content elements; annotation of content elements; number of participants viewing at least one content element; identities of viewers viewing at least one content element; content elements selected as a collaboration session focus by at least one participant of the collaboration session; user input of at least one participant; for at least one content element, duration of focus by at least one participant; view mode of at least one participant (e.g., “Focus View Mode”, “Room View Mode”, “Focus View Mode with Follow Disabled”); participant sentiment data associated with the content element; and participant reaction data associated with the content element.

In some embodiments, S240 includes the collaboration system 110 providing the content of the collaboration session to each participant device of the collaboration session (e.g., 121-125). In some embodiments, a collaboration appliance can function as a participant system, and S240 can include additionally providing the content of the collaboration session to each collaboration appliance (e.g., 144), which displays the received content on at least one display device (e.g., 157, 158).

In some embodiments, S240 includes the collaboration system 110 controlling a display system (e.g., 151 and 152 coupled to 141, 153 and 155 coupled to 142, 156 coupled to 143, and 157 and 158 coupled to 144) communicatively coupled to the collaboration system to display the content of the collaboration session across one or more display devices (e.g., 151-158) in accordance with at least a portion of the context information. In some embodiments, displaying the content by using the collaboration system includes displaying at least one visual indicator generated based on the context information.

In some embodiments, S240 includes generating at least one of content layout information for the collaboration session and a content rendering of the collaboration session based on the context information generated at S230.

In some embodiments, the context information includes the relevancy ordering generated at S231, and S241 includes generating at least one of content layout information for the collaboration session and a content rendering of the collaboration session based on the relevancy ordering identified.

In some embodiments, the context information includes the canonical geometry generated at S232, and S242 includes generating at least one of content layout information for the collaboration session and a content rendering of the collaboration session based on the canonical geometry identified by the context information generated at S232.

In some embodiments, the context information includes a canvas layout of content elements within a canvas, and S240 includes generating at least one of content layout information for the collaboration session and a content rendering of the collaboration session based on the canvas layout identified by the context information generated at S230.

In some embodiments, the collaboration system no generates a content rendering for each participant system, thereby providing a unique view to each participant of the collaboration session. In some embodiments, the collaboration system 110 generates a shared content rendering for at least two participant systems that subscribe to a shared view. In some embodiments, each participant system subscribing to the shared view receives the shared content rendering of the collaboration session, such that each participant system subscribing to the shared view displays the same rendering. In some embodiments, at least one participant generates a content rendering of the collaboration session, based on content and layout information received from the collaboration system (e.g, 110).

In some embodiments, S250 functions to provide at least a portion of the generated context information to at least one participant system (and optionally at least one collaboration appliance, e.g., 144). In some embodiments, each system receiving the context information from the collaboration system 110 generates a content rendering of the collaboration session based on the received context information and the received content. In some embodiments, the received context information includes the relevancy ordering determined at S231, and at least one system receiving the context information from the collaboration system 110 generates a content rendering of the collaboration session based on the relevancy ordering (identified by the received context information) and the received content. In some embodiments, the received context information includes the canonical geometry determined at S232, and at least one system receiving the context information from the collaboration system 110 generates a content rendering of the collaboration session based on the canonical geometry (identified by the received context information) and the received content. In some embodiments, the received context information includes the canvas layout determined at S230, and at least one system receiving the context information from the collaboration system 110 generates a content rendering of the collaboration session based on the canvas layout (identified by the received context information) and the received content.

In some embodiments, at least one participant system displays the received content in accordance with the context information. In some embodiments, displaying the content by a participant device includes displaying at least one visual indicator generated based on the context information.

S260 functions to update the context information.

In some embodiments, the collaboration system 110 updates the context information in response to a change in at least one of the factors used to generate the context information at S230. In some embodiments, S260 includes updating the relevancy ordering S262. In some embodiments, S260 includes updating the canvas layout. In some embodiments, the collaboration system 110 updates the relevancy ordering in response to a change in at least one of: visibility of a content element; content elements included in the collaboration session; size of a content element; occlusion of a content element; order of the content elements included in the collaboration session; content type of a content element; interaction with a content element; pointing focus; annotation on a content element; number of participants viewing a content element; identities of viewers viewing a content element; for at least one content element, cumulative duration of focus for the content element during the collaboration session; for at least one content element, most recent duration of focus for the content element; the content element having the longest duration of focus for the collaboration session; selection of a focus of the collaboration session; participant sentiment data associated with the content element; and participant reaction data associated with the content element. In some embodiments, the collaboration system 110 updates the context information in response to collaboration input received for the collaboration session.

In some embodiments, S260 includes updating the canonical geometry S263. In some implementations, S260 includes updating the canonical geometry S263 based on a reconfiguration of a display system of at least one of a participant system (e.g., 121-125) and a display system (e.g., 151-158) that is communicatively coupled to a collaboration server (e.g., servers 141-144).

In some embodiments, S260 includes receiving participant context information for at least one participant system S261. In some embodiments, S260 includes updating the context information based on the received participant context information. In some embodiments, the collaboration system 110 updates the context information in response to updated participant context information received for the collaboration session. In some embodiments, participant context information received for a participant system identifies at least one of: a view mode of the participant device (e.g., “Room View”, “Focus View”, Focus View Follow Disabled”, etc.); cursor state of a cursor of the participant system; annotation data generated by the participant system; a content element selected as a current focus by the participant system; a user identifier associated with the participant system; and a canvas layout of the content elements of the collaboration session within a canvas displayed by the participant system. In some embodiments, S260 includes updating a canvas layout for the collaboration session based on the received participant context information.

S270 functions to provide the updated context information to at least one participant system (and optionally at least one collaboration appliance, e.g., 144). In some embodiments, at least one system receiving the updated context information from the collaboration system 110 generates a content rendering of the collaboration session based on the received updated context information (e.g., S280). In some embodiments, the updated context information includes an updated relevancy ordering (e.g., updated at S262), and at least one system receiving the updated context information from the collaboration system 110 generates a content rendering of the collaboration session based on the updated relevancy ordering included in the received updated context information (e.g., S281). In some embodiments, the updated context information includes an updated canonical geometry (e.g., updated at S263), and at least one system receiving the updated context information from the collaboration system 110 generates a content rendering of the collaboration session based on the updated canonical geometry included in the received updated context information (e.g., S282). In some embodiments, the updated context information includes an canvas layout (e.g., updated at S260), and at least one system receiving the updated context information from the collaboration system 110 generates a content rendering of the collaboration session based on the updated canvas layout included in the received updated context information (e.g., S280).

In some embodiments, S280 includes updating display of the content based on the updated relevancy ordering S281.

In some embodiments, S280 includes updating display of the content based on the updated canonical geometry S282.

In some embodiments, S280 includes the collaboration system (e.g., 110) updating content layout information for the collaboration session based on the updated context information generated at S260, and providing the updated content layout information to at least one participant system (e.g., 121-125) (and optionally at least one collaboration appliance, e.g., 144). In some embodiments, S281 includes the collaboration system (e.g., 110) updating content layout information for the collaboration session based on the updated relevancy ordering generated at S262, and providing the updated content layout information to at least one participant system (e.g., 121-125) (and optionally at least one collaboration appliance, e.g., 144). In some embodiments, S282 includes the collaboration system (e.g., 110) updating content layout information for the collaboration session based on the updated canonical geometry generated at S262, and providing the updated content layout information to at least one participant system (e.g., 121-125) (and optionally at least one collaboration appliance, e.g., 144). In some embodiments, S280 includes the collaboration system (e.g., 110) updating content layout information for the collaboration session based on the updated canvas layout generated at S260, and providing the updated content layout information to at least one participant system (e.g., 121-125) (and optionally at least one collaboration appliance, e.g., 144).

In some embodiments, S280 includes the collaboration system (e.g., 110) updating the content rendering of the collaboration session for the collaboration session based on the updated context information generated at S260, and providing the updated content rendering to at least one participant system (e.g., 121-125) (and optionally at least one collaboration appliance, e.g., 144). In some embodiments, S281 includes the collaboration system (e.g., 110) updating the content rendering of the collaboration session for the collaboration session based on the updated relevancy ordering generated at S262, and providing the updated content rendering to at least one participant system (e.g., 121-125) (and optionally at least one collaboration appliance, e.g., 144). In some embodiments, S282 includes the collaboration system (e.g., 110) updating the content rendering of the collaboration session for the collaboration session based on the updated canonical geometry generated at S263, and providing the updated content rendering to at least one participant system (e.g., 121-125) (and optionally at least one collaboration appliance, e.g., 144). In some embodiments, S282 includes the collaboration system (e.g., 110) updating the content rendering of the collaboration session for the collaboration session based on the updated canvas layout generated at S260, and providing the updated content rendering to at least one participant system (e.g., 121-125) (and optionally at least one collaboration appliance, e.g., 144).

In some embodiments, S280 includes the collaboration system 110 controlling a display system (e.g., 151 and 152 coupled to 141, 153 and 155 coupled to 142, 156 coupled to 143, and 157 and 158 coupled to 144) communicatively coupled to the collaboration system to display the content across one or more display devices (e.g., 151-158) in accordance with the updated context information.

Canonical Geometry

In some embodiments, S232 includes determining the canonical geometry based on display information of the at least one display system (e.g., 171, 172 shown in FIG. 1B). In some embodiments, collaboration system 110 determines the canonical geometry based on display information of a first display system (e.g., 171) and at least one of: display information of a remote second display system (e.g., 172); and display information of the display device (e.g., 156) of remote collaboration client device (e.g., 143) (e.g., a laptop, a desktop, etc.). In some embodiments, collaboration servers (e.g., 141-143) exchange at least one of display information and a generated canonical geometry. In some embodiments, the collaboration system includes a plurality of collaboration servers (e.g., 141, 142) and at least one of the collaboration servers (individually or collectively) generates the canonical geometry based on display information for the display systems coupled to the collaboration system.

In some embodiments, S263 includes the collaboration system updating the canonical geometry based on a change in display geometry (e.g., addition of a display device, removal of a display device, repositioning of a display device, failure of a display device, etc.) of at least one display system coupled to the collaboration system (or coupled to a collaboration device, e.g., 143).

In some embodiments, the canonical geometry is managed by a plurality of devices (e.g., 141-143) included in the collaboration system 110, and the canonical geometry is synchronized among the plurality of devices that manage the canonical geometry. In some embodiments, the canonical geometry is centrally managed by a single collaboration server.

Relevancy Stack

In some embodiments, the relevancy stack is a data structure stored on a storage device included in the collaboration system 110.

In some embodiments, the relevancy stack is managed by a plurality of devices included in the collaboration system 110, and the relevancy stack is synchronized among the plurality of devices that manage the relevancy stack. In some embodiments, the relevancy stack is centrally managed by a single collaboration server.

Visual Indictors

In some embodiments, displaying the content of the collaboration session (e.g., by the collaboration system or by a participant system) includes displaying at least one visual indicator. In some embodiments, at least one displayed visual indicator relates to at least one visible content element included in the collaboration session. In some embodiments, at least one visual indicator is generated by the collaboration system 110 based on the generated context information.

In some embodiments, at least one visual indicator is generated by a participant device, based on the context information.

In some embodiments, displaying at least one visual indicator includes displaying at least one visual indicator that identifies which display device of a multi-display system (e.g., 171 shown in FIG. 1B) displays a content element of the collaboration session that is a current focus. In some implementations, a content element that is a current focus is the content element at the top of the relevancy stack. In some implementations, a content element that is a current focus is the content element that has the highest order in the relevancy ordering (e.g., the first content element identified in the relevancy ordering).

In some embodiments, displaying at least one visual indicator includes displaying at least one visual indicator that identifies a displayed a content element of the collaboration session that is a current focus.

In some embodiments, displaying at least one visual indicator includes displaying at least one visual indicator that identifies a portion of a displayed content element of the collaboration session that is a current focus. In some implementations, a portion of the content element that is a current focus is the portion of the content element at the top of the relevancy stack that is identified as the focus of the top content element by the context information.

Visual Indicator Identifying Number of Participants

In some embodiments, displaying at least one visual indicator includes displaying at least one visual indicator that identifies a number of participant systems that are viewing each display region of a display system (e.g., 171), as identified by the context information.

In some embodiments, displaying at least one visual indicator includes displaying at least one visual indicator that identifies a number of participant systems that are viewing each content element of the collaboration session, as identified by the context information.

Visual Indicator Identifying Participants

In some embodiments, displaying at least one visual indicator includes displaying at least one visual indicator that identifies for each display region of a display system (e.g., 171) the identities of each participant viewing the display region, as identified by the context information.

In some embodiments, displaying at least one visual indicator includes displaying at least one visual indicator that indicates for each content element of the collaboration session, the identifies of each participant viewing the content element, as identified by the context information.

Content

In some embodiments, the content elements of the collaboration session include static digital elements (e.g., fixed data, images, and documents). In some embodiments, the content elements include dynamic digital streams (e.g., live applications, interactive data views, and entire visual-GUI environments). In some embodiments, the content elements include live video streams (e.g., whiteboard surfaces and audio and video of human participants). In some embodiments, the content elements include live audio streams (e.g., audio of human participants).

In some embodiments, the content of the collaboration session includes content provided by at least one participant system (e.g., 121-125) that is communicatively coupled to the collaboration system 110. In some embodiments, the content of the collaboration session includes content provided by at least one cognitive agent (e.g., a cognitive agent running on the collaboration system, a collaboration appliance 144 coupled to the collaboration system, etc.). In some embodiments, the content of the collaboration session includes content provided by at least one cognitive agent in response to external data (e.g., alerts, observations, triggers, and the like). In some embodiments, the content of the collaboration session includes content provided by at least one cognitive agent based on analysis of internal meeting dynamics (e.g., verbal cues, video recognition, and data within the content streams). In some embodiments, the collaboration system is communicatively coupled to (or includes) at least one of an audio sensing device and an image sensing device. In some embodiments, content is received via a network resource (e.g., an external web site, cloud-server, etc.). In some embodiments, content is received via a storage device (e.g., a flash drive, a portable hard drive, a network attached storage device, etc.) that is communicatively coupled to the collaboration system 110 (e.g., via a wired interface, a wireless interface, etc.).

Establishing the Collaboration Session

In some embodiments, the collaboration system establishes one or more collaboration sessions. In some embodiments in which the collaboration system 110 includes a plurality of collaboration servers (e.g, 141, 142) communicating via one or more peer-to-peer communication sessions, a first one of the collaboration servers (e.g., 141) establishes the collaboration session, and the a second one of the collaboration servers (e.g., 142) joins the established collaboration session.

Context

In some embodiments, the collaboration system (e.g., 110) manages the context information of the collaboration session. In some embodiments the context information identifies primary context and secondary context.

In some embodiments, primary context includes at least one of (1) static and stream content, including interaction with and manipulation of individual streams; (2) interaction among the participants; and (3) the specific moment-to-moment geometric arrangement of multiple pieces of content across display devices of the first display system. In some embodiments, the interaction among the participants includes verbal interaction among the participants (as sensed by at least one audio sensing device that is communicatively coupled to the collaboration system 110). In some embodiments, the interaction among the participants includes human-level interaction among the participants (as sensed by at least one sensing device that is communicatively coupled to the collaboration system 110).

In some embodiments, secondary context includes identity, location, and activity of at least one participant of the collaboration session. In some embodiments, secondary context includes causal linkage between participants and changes to content streams and other elements of the state of the collaboration session. In some embodiments, secondary context includes derived quantities such as inferred attention of participant subsets to particular content streams or geometric regions in the layout of the content of the first collaboration session.

Participant Systems

In some embodiments, each participant system (e.g., 121-127) communicatively coupled to the collaboration system 110 corresponds to a human participant of the first collaboration session.

Updating the Relevancy Ordering

In some embodiments, the relevancy ordering (e.g., represented by the relevancy stack) is updated responsive to addition of a new content element to the collaboration session.

In some embodiments, the relevancy ordering is updated responsive to removal of a content element from the collaboration session.

In some embodiments, the relevancy ordering is updated responsive to change in display size of at least one content element of the collaboration session.

In some embodiments, the relevancy ordering is updated responsive to change in display visibility of at least one content element of the collaboration session.

In some embodiments, the relevancy ordering is updated responsive to an instruction to update the relevancy ordering.

In some embodiments, the relevancy ordering is updated responsive to detection of user interaction with at least one content element of the collaboration session.

In some embodiments, the relevancy ordering is updated responsive to detection of user selection (e.g., user selection received via a pointer) of at least one content element of the collaboration session.

In some embodiments, the relevancy ordering is updated responsive to annotation of at least one content element of the collaboration session.

In some embodiments, the relevancy ordering is updated responsive to non-verbal input (sentiment, emoji reactions, etc.) of at least one content element of the collaboration session.

In some embodiments, the relevancy ordering is updated responsive to a change in number of detected viewers of at least one content element of the collaboration session.

In some embodiments, the relevancy ordering is updated responsive to a change in detected participants viewing at least one content element of the collaboration session.

In some embodiments, the relevancy ordering is updated responsive to an instruction selecting a content element as a current focus of the collaboration session.

In some embodiments, a cognitive agent updates relevancy ordering. In some embodiments, the cognitive agent updates the relevancy ordering by adding a content element to the communication session. In some embodiments, the cognitive agent updates the relevancy ordering by removing a content element from the communication session. In some embodiments, the cognitive agent updates the relevancy ordering by updating display of a content element of the communication session. In some embodiments, the cognitive agent updates the relevancy ordering by selecting a content element as a current focus of the communication session. In some embodiments, the cognitive agent updates the relevancy ordering by selecting a content element as a current focus of the communication session based on an analysis of external data. In some embodiments, the cognitive agent updates the relevancy ordering by selecting a content element as a current focus of the communication session based on an analysis of a monitored discussion (e.g., by selecting content relevant to the discussion).

In some embodiments, the content element (e.g., in the relevancy stack) are ordered in accordance with content type.

### Viewing Modes

In some embodiments, the method 200 includes at least one of a participant system (e.g., 121-125) and a remote collaboration device (e.g., 143) displaying content of the collaboration session at a display device (e.g., a display device included in the participant system, an external display device, etc.) in accordance with the context information generated and provided by the collaboration system 110.

In some embodiments, the method 200 includes at least one of a participant system (e.g., 121-125) and a remote collaboration device (e.g., 143) displaying content of the collaboration session at a display device (e.g., a display device included in the participant system, an external display device, etc.) in accordance with a selected display mode. In some embodiments, the display mode is identified by the context information. In some embodiments, the display mode is selected based on user input received by a participant system (or remote collaboration device) via a user input device.

In some embodiments, display modes include at least a first remote display mode and a second remote display mode. In some embodiments, the first remote display mode is a Room View mode and the second remote display mode is a Focus View mode.

In some embodiments, the method 200 includes: at least one of a participant system (e.g., 121-125) and a remote collaboration device (e.g., 143) maintaining a relevancy stack responsive to information received by the remote collaboration system.

Focus View

In some embodiments, displaying content of the collaboration session at a display device (e.g., a display device included in the participant system, an external display device, etc.) in accordance with a selected Focus View mode includes: displaying a single content element of the collaboration session.

In some embodiments, displaying content of the collaboration session at a display device (e.g., a display device included in the participant system, an external display device, etc.) in accordance with a selected Focus View mode having a Follow mode is enabled includes: displaying a content element of the collaboration session that is the current focus of the collaboration session (or the current focus of a participant being followed by a participant associated with the participant system displaying the content). In the follow mode, the participant system displays a new content element responsive to a change in the current focus as indicated by the relevancy ordering. In some embodiments, the current focus is the content element at the top of the relevancy stack.

In some embodiments, the participant system automatically enables the Follow mode responsive to enabling the Focus View mode. In some embodiments, the participant system enables the follow mode responsive to receiving user input (via a user input device of the participant system) indicating selection of the follow mode.

In some embodiments, in a case where the focus view mode is enabled at the participant system and a Follow mode is disabled, the participant system maintains display of a current content element at the participant system responsive to a change in the current focus as indicated by the relevancy stack. In other words, with follow mode disabled, the content element displayed by the participant system does not change in the focus view mode when the current focus changes.

In some embodiments, in a case where the focus view mode is enabled at the remote collaboration client device and a Follow mode is disabled, the participant system displays a new content element responsive to reception of user selection of the new content element via a user input device that is communicatively coupled to the participant system.

In some embodiments, in a case where the focus view mode is enabled at the participant system, a Follow mode is disabled; with the Follow mode disabled for Focus View mode, the participant system device receives user selection of a new content element via a user input device, and the collaboration system 110 determines whether to update the relevancy stack based on the selection of the new content element at the participant system. In other words, in some embodiments, selection of a content element in the focus view does not automatically move the selected content element to the top of the relevancy stack, but rather the selection is used as information to determine whether to move the selected content element to the top of the relevancy stack. In some embodiments, in a collaboration session with multiple participant systems, selection of a same content element by a number of the participant systems results in a determination to update the relevancy stack to include the selected content element at the top of the stack.

Room View

In some embodiments, the participant system stores a canonical geometry (e.g., included in received context information), as described herein.

In some embodiments, displaying content of the collaboration session at a display device (e.g., a display device included in the participant system, an external display device, etc.) in accordance with a selected Room View mode includes: displaying all content elements of the communication session according to a layout defined by the canonical geometry. In some embodiments, in a case where the Room View mode is enabled at the participant system, the participant system displays all content elements of the communication session according to a layout defined by the canonical geometry, including a depiction of individual display devices (e.g., 153-155) of a collaboration server (e.g., 142) for a second room (e.g., “Second Location”).

In some embodiments, in a case where the Room View mode is enabled, the canonical geometry is updated in response to layout update instructions received by the participant system via a user input device of the participant system. In some embodiments, the participant system updates the canonical geometry.

Manual Focus

In some embodiments, the method includes: a participant system receiving user selection of content element of the communication session via a user input device that is communicatively coupled to the participant system, and updating the focus of the collaboration session to be the selected content element. In some embodiments, the participant system updates the focus by adding the selected content element to the top of the relevancy stack. In some embodiments, the participant system updates the focus by sending a notification to a collaboration system to add the selected content element to the top of the relevancy stack.

Focus Flip-Flop

In some embodiments, in a case where the Focus View mode is enabled at a participant system and a Follow mode is enabled, the participant system displays a new content element responsive to reception of user selection of the new content item via a user input device that is communicatively coupled to the participant system; and responsive to a change in the current focus as indicated by the relevancy stack, the participant system displays the content element that is the current focus. In some embodiments, in a case where the Focus View mode is enabled at a participant system and a Follow mode is enabled, the participant receives user selection to switch from display of a first focused content element and a second focused content element. In some embodiments, the first focused content element is a content element selected responsive to user selection received by the participant system, and the second focused content element is a content element that is identified by the relevancy ordering (e.g., relevancy stack) as a focused content element. In some embodiments, the first focused content element is a content element that is identified by the relevancy ordering (e.g., relevancy stack) as a focused content element, and the second focused content element is a content element selected responsive to user selection received by the participant system.

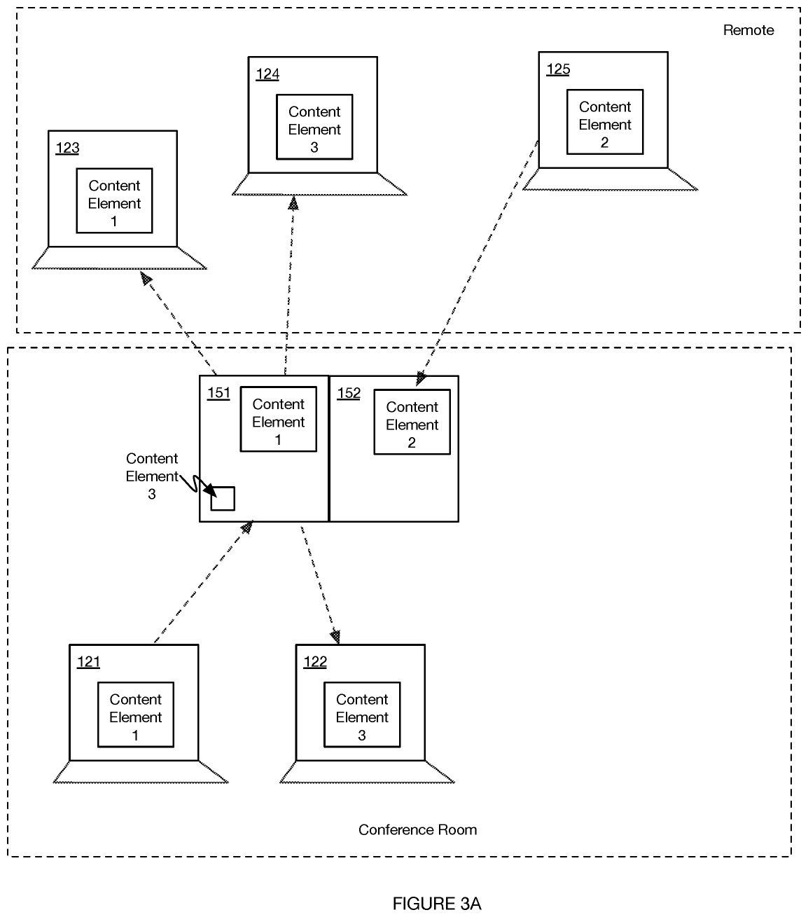

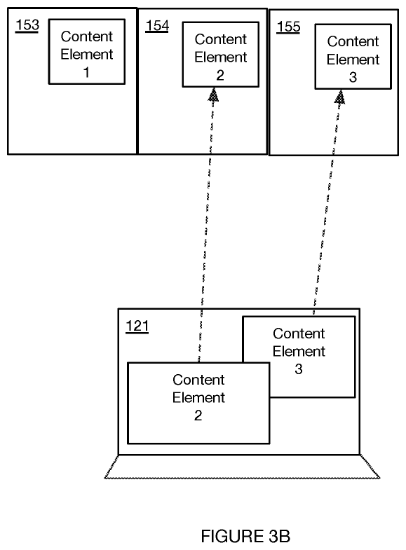

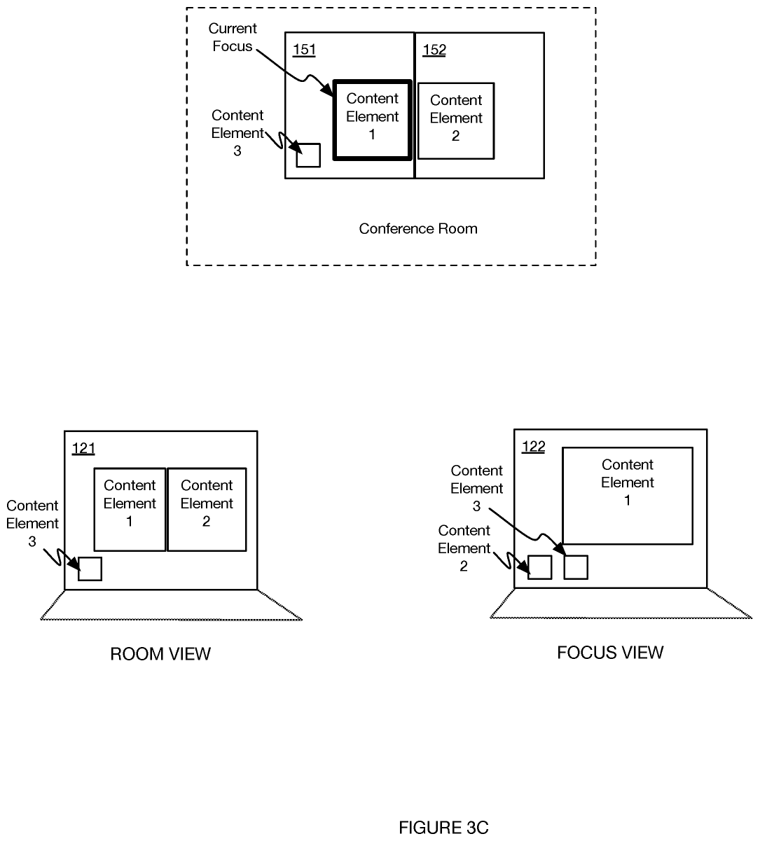

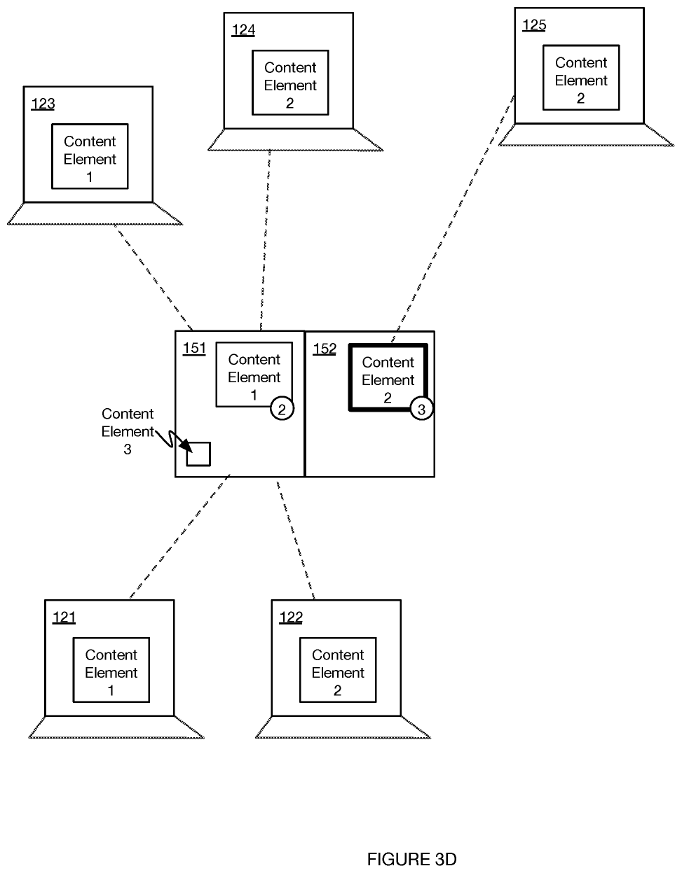

FIGS. 3A-D

FIGS. 3A-D are visual representations of exemplary collaboration sessions according to embodiments. As shown in FIG. 3A, content streams can be parallelized, such that many devices (e.g., 121-125) can send content streams to the collaboration system 110, and simultaneously receive content streams from the collaboration system 110.

As shown in FIG. 3B, a single participant device may contribute multiple streams of content to the collaboration system 110 simultaneously.

As shown in FIG. 3C, Focus View Mode can emphasize a single selection of content for viewing on smaller displays, whereas Room View mode can a provide a geometric representation of content in a shared context. For example, in Room View, a participant device can display a representation that identifies how content is displayed across display devices in a conference room.

As shown in FIG. 3C, Focus View can emphasize one content stream while providing access to all other content streams with a single selection. In some implementations, Focus View includes reduced representations (e.g., thumbnails) of all content elements of the collaboration session, such that selection of a representation changes focus to the content element related to the selected representation. As shown in FIG. 3C, content elements 2 and 3 are displayed at participant device 122 as reduced representations, while content element 1 is displayed as the focused element.

As shown in FIG. 3D, the collaboration system 110 can infer attention based on the currently focused content stream across all participants in the collaboration session. As shown in FIG. 3D, three participants devices are displaying content element 2, whereas two participant devices are displaying content element 1, and thus content element 2 is selected as the currently focused content stream. As shown in FIG. 3D, a visual indicator displayed by display device 152 identifies that three participant devices are displaying content element 2, and visual indicator displayed by display device 151 identifies that two participant devices are displaying content element 1. As shown in FIG. 3D, display device 152 displays a bounding box that identifies content element 2 as the currently focused content element. In some implementations, attention can be indicated with varying specificity, via explicit identity, count, or visual effect proportional to its inferred value.

In some implementations, a participant device displays a user interface element that notifies the user of the participant device that their screen is shared, but not visible, and receives at least one of user selection to set the user's screen as the current focus for the collaboration session, and user selection to stop screen sharing.

### System Architecture

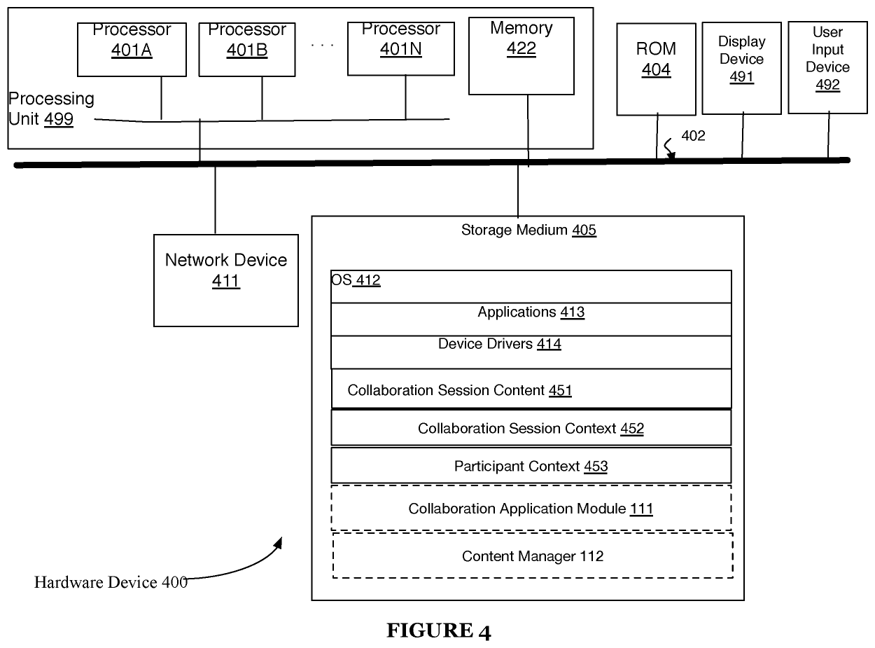

FIG. 4

In some embodiments, the collaboration system 110 is implemented as a single hardware device (e.g., 400 shown in FIG. 4). In some embodiments, the collaboration system 110 is implemented as a plurality of hardware devices (e.g., 400 shown in FIG. 4). FIG. 4 is an architecture diagram of a hardware device 400 in accordance with embodiments.

In some embodiments, the hardware device 400 includes a bus 402 that interfaces with the processors 401A-401N, the main memory (e.g., a random access memory (RAM)) 422, a read only memory (ROM) 404, a processor-readable storage medium 405, and a network device 411. In some embodiments, the hardware device 400 is communicatively coupled to at least one display device (e.g., 491). In some embodiments the hardware device 400 includes a user input device (e.g., 492). In some embodiments, the hardware device 400 includes at least one processor (e.g., 401A).

The processors 401A-401N may take many forms, such as one or more of a microcontroller, a CPU (Central Processing Unit), a GPU (Graphics Processing Unit), and the like. In some embodiments, the hardware device 400 includes at least one of a central processing unit (processor), a GPU, and a multi-processor unit (MPU).

The processors 401A-401N and the main memory 422 form a processing unit 499. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

The network device 411 provides one or more wired or wireless interfaces for exchanging data and commands between the hardware device 400 and other devices, such as a participant system (e.g., 121-125). Such wired and wireless interfaces include, for example, a universal serial bus (USB) interface, Bluetooth interface, Wi-Fi interface, Ethernet interface, InfiniBand interface, Fibre Channel interface, near field communication (NFC) interface, and the like.

Machine-executable instructions in software programs (such as an operating system, application programs, and device drivers) are loaded into the memory 422 (of the processing unit 499) from the processor-readable storage medium 405, the ROM 404 or any other storage location. During execution of these software programs, the respective machine-executable instructions are accessed by at least one of processors 401A-401N (of the processing unit 499) via the bus 402, and then executed by at least one of processors 401A-401N. Data used by the software programs are also stored in the memory 422, and such data is accessed by at least one of processors 401A-401N during execution of the machine-executable instructions of the software programs. The processor-readable storage medium 405 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

In some embodiments, the processor-readable storage medium 405 includes machine-executable instructions (and related data) for at least one of: an operating system 412, software programs 413, device drivers 414, a collaboration application module 111, and a content manger 112. In some embodiments, the processor-readable storage medium 405 includes at least one of: collaboration session content 451 for at least one collaboration session, collaboration session context information 452 for at least one collaboration session, and participant context information 453 for at least one collaboration session.

In some embodiments, the collaboration application module 111 includes machine-executable instructions that when executed by the hardware device 400, cause the hardware device 400 to perform at least a portion of the method 200, as described herein.

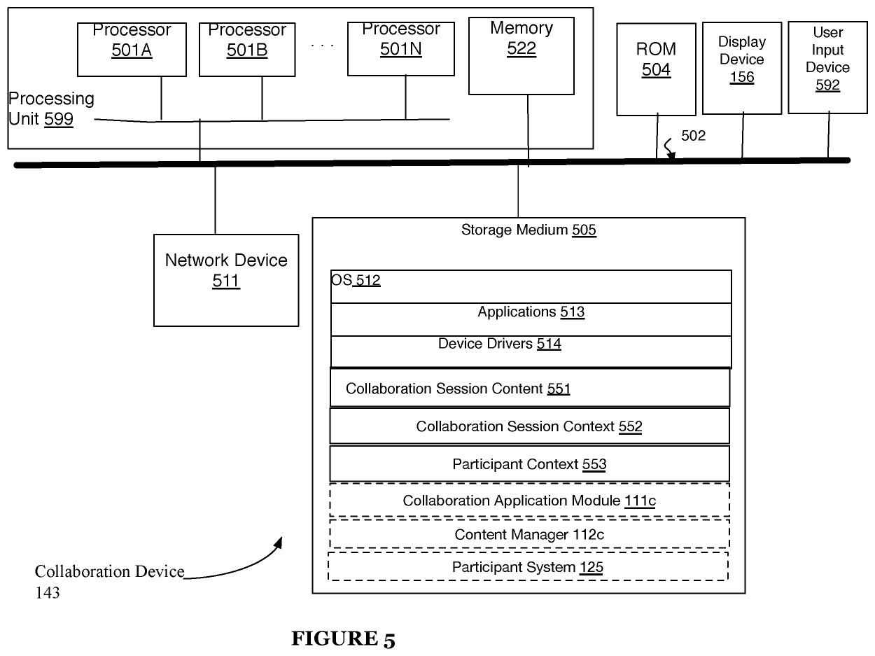

FIG. 5

In some embodiments, the collaboration device 143 is implemented as a single hardware device (e.g., 500 shown in FIG. 5). In some embodiments, the collaboration device 143 is implemented as a plurality of hardware devices (e.g., 500 shown in FIG. 5).

In some embodiments, the collaboration device 143 includes a bus 502 that interfaces with the processors 501A-501N, the main memory (e.g., a random access memory (RAM)) 522, a read only memory (ROM) 504, a processor-readable storage medium 505, and a network device 511. In some embodiments, the collaboration device 143 is communicatively coupled to at least one display device (e.g., 156). In some embodiments the collaboration device 143 includes a user input device (e.g., 592). In some embodiments, the collaboration device 143 includes at least one processor (e.g., 501A).

The processors 501A-501N may take many forms, such as one or more of a microcontroller, a CPU (Central Processing Unit), a GPU (Graphics Processing Unit), and the like. In some embodiments, the collaboration device 143 includes at least one of a central processing unit (processor), a GPU, and a multi-processor unit (MPU).

The processors 501A-501N and the main memory 522 form a processing unit 599. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

The network device 511 provides one or more wired or wireless interfaces for exchanging data and commands between the collaboration device 143 and other devices. Such wired and wireless interfaces include, for example, a universal serial bus (USB) interface, Bluetooth interface, Wi-Fi interface, Ethernet interface, InfiniBand interface, Fibre Channel interface, near field communication (NFC) interface, and the like.

Machine-executable instructions in software programs (such as an operating system, application programs, and device drivers) are loaded into the memory 522 (of the processing unit 599) from the processor-readable storage medium 505, the ROM 404 or any other storage location. During execution of these software programs, the respective machine-executable instructions are accessed by at least one of processors 501A-501N (of the processing unit 599) via the bus 502, and then executed by at least one of processors 501A-501N. Data used by the software programs are also stored in the memory 522, and such data is accessed by at least one of processors 501A-501N during execution of the machine-executable instructions of the software programs. The processor-readable storage medium 505 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

In some embodiments, the processor-readable storage medium 505 includes machine-executable instructions (and related data) for at least one of: an operating system 512, software programs 513, device drivers 514, a collaboration application module 111c, a content manger 112c, and a participant system 125. In some embodiments, the processor-readable storage medium 505 includes at least one of: collaboration session content 551 for at least one collaboration session, collaboration session context information 552 for at least one collaboration session, and participant context information 553 for at least one collaboration session.

In some embodiments, the collaboration application module 111 includes machine-executable instructions that when executed by the hardware device 400, cause the hardware device 400 to perform at least a portion of the method 200, as described herein.

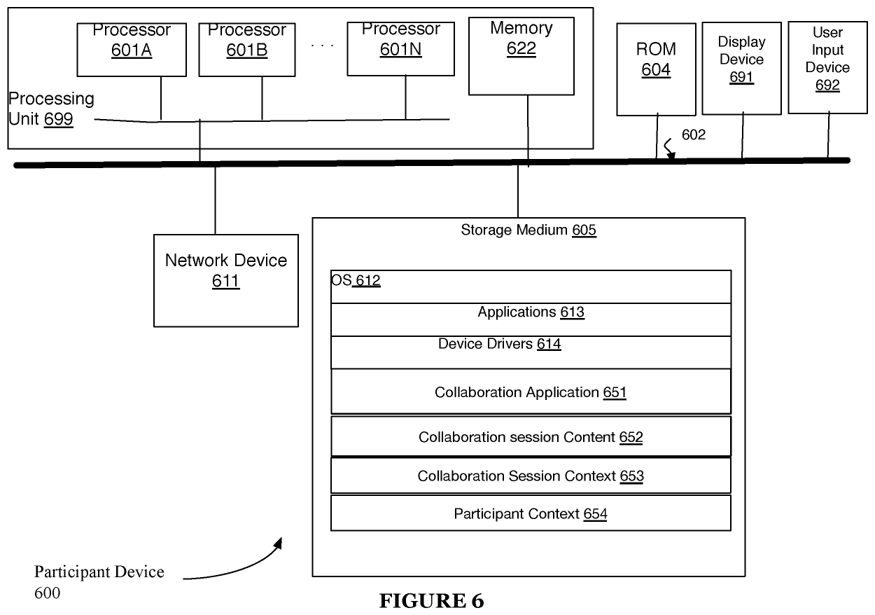

FIG. 6

FIG. 6 is an architecture diagram of a participant system 600 in accordance with embodiments. In some embodiments, the participant system 600 is similar to the participant systems 121-127.

In some embodiments, the participant system 600 includes a bus 602 that interfaces with the processors 601A-601N, the main memory (e.g., a random access memory (RAM)) 622, a read only memory (ROM) 604, a processor-readable storage medium 605, and a network device 611. In some embodiments, the participant system 600 is communicatively coupled to at least one display device (e.g., 691). In some embodiments the participant system 600 includes a user input device (e.g., 692). In some embodiments, the participant system 600 includes at least one processor (e.g., 601A).

The processors 601A-601N may take many forms, such as one or more of a microcontroller, a CPU (Central Processing Unit), a GPU (Graphics Processing Unit), and the like. In some embodiments, the participant system 600 includes at least one of a central processing unit (processor), a GPU, and a multi-processor unit (MPU).

The processors 601A-601N and the main memory 622 form a processing unit 699. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

The network device 611 provides one or more wired or wireless interfaces for exchanging data and commands between the participant system 600 and other devices, such as collaboration server. Such wired and wireless interfaces include, for example, a universal serial bus (USB) interface, Bluetooth interface, Wi-Fi interface, Ethernet interface, InfiniBand interface, Fibre Channel interface, near field communication (NFC) interface, and the like.

Machine-executable instructions in software programs (such as an operating system, application programs, and device drivers) are loaded into the memory 622 (of the processing unit 699) from the processor-readable storage medium 605, the ROM 604 or any other storage location. During execution of these software programs, the respective machine-executable instructions are accessed by at least one of processors 601A-601N (of the processing unit 699) via the bus 602, and then executed by at least one of processors 601A-601N. Data used by the software programs are also stored in the memory 622, and such data is accessed by at least one of processors 601A-601N during execution of the machine-executable instructions of the software programs. The processor-readable storage medium 605 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

In some embodiments, the processor-readable storage medium 605 includes machine-executable instructions (and related data) for at least one of: an operating system 612, software programs 613, device drivers 614, and a collaboration application 651. In some embodiments, the collaboration application is similar to the collaboration applications 131-135 described herein. In some embodiments, the processor-readable storage medium 605 includes at least one of: collaboration session content 652 for at least one collaboration session, collaboration session context information 653 for at least one collaboration session, and participant context information 654 for at least one collaboration session.

In some embodiments, the collaboration application 651 includes machine-executable instructions that when executed by the participant device 600, cause the participant device 600 to perform at least a portion of the method 200, as described herein.

### Machines

The systems and methods of the embodiments and embodiments thereof can be embodied and/or implemented at least in part as a machine configured to receive a computer-readable medium storing computer-readable instructions. The instructions are preferably executed by computer-executable components preferably integrated with the spatial operating environment system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

### CONCLUSION

As a person skilled in the art will recognize from the previous detailed description and from the figures and claims, modifications and changes can be made to the embodiments disclosed herein without departing from the scope defined in the claims.

What is claimed is:

1. A method comprising: with a collaboration system:
establishing a collaboration session with a plurality of participant devices via at least one network;
receiving at least one content stream from at least two of the plurality of participant devices, the received content streams including at least one video stream and at least three screen share streams;
adding the received content streams to the collaboration session as content of the collaboration session;
generating context information for the collaboration session comprising: generating a relevancy ordering of all content streams of the collaboration session according to relevance;
providing the content of the collaboration session to each of the plurality of participant devices;
providing at least a portion of the context information to each of the plurality of participant devices;
receiving participant context information from at least one participant device;
updating the context information for the collaboration session based on the received participant context information, comprising: updating the relevancy ordering of the context information; and
providing at least the updated relevancy ordering of the updated context information to each of the plurality of participant devices.

2. The method of claim 1, further comprising: with the collaboration system, updating display of the content of the collaboration session at a display system coupled to the collaboration system, based on the updated relevancy ordering.

3. The method of claim 1, further comprising: with at least a first participant device that receives the content and the context information from the collaboration system, updating display of the content of the collaboration session at a display device of the first participant device, based on the updated relevancy ordering.

4. The method of claim 1, wherein the participant context information provided by a participant device includes at least one of: a view mode of the participant device; cursor state of a cursor of the participant device; annotation data generated by the participant device; a content element selected as a current focus by the participant device; a user identifier associated with the participant device; a canvas layout of the content elements of the collaboration session within a canvas displayed by the participant system; and participant sentiment data associated with the content element; and participant reaction data associated with the content element.

5. The method of claim 4, wherein updating the relevancy ordering comprises: updating the relevancy ordering based on at least one of a promotional cue and a demotional cue identified by the received participant context information.

6. The method of claim 4, wherein updating the relevancy ordering comprises: ordering the content elements in accordance with a number of participant devices displaying each content element, as identified by the received participant context information.

7. The method of claim 6, wherein updating the relevancy ordering comprises: determining the relevancy ordering in accordance identities of users viewing the content elements, as identified by the received participant context information.

8. The method of claim 4, wherein updating the relevancy ordering comprises: updating the relevancy ordering in response to at least one of selection of at least one content element, annotation of at least one content element, addition of participant sentiment data for at least one content element, and addition of participant reaction data for at least one content element, as identified by the received participant context information.

9. The method of claim 1,
further comprising: with at least a first participant device that receives the content and the context information from the collaboration system, updating display of the content of the collaboration session at a display device of the first participant device, based on the updated relevancy ordering,
wherein updating display of the content of the collaboration session at the display device of the first participant device comprises: displaying a visual indicator that identifies a content element of the collaboration session that has a current focus, as indicated by the updated relevancy ordering.

10. The method of claim 9, wherein the content element of the collaboration session that has the current focus is the content element that is the first content element identified in the relevancy ordering.

11. The method of claim 10,
wherein the context information identifies, for at least one content element of the collaboration session, at least one of:
a number of participant devices displaying the content element; and
a user identity of at least one participant whose participant device is displaying the content element.

12. The method of claim 11,
wherein updating context information for the collaboration session comprises at least one of:
for at least one content element, updating information identifying a number of participants displaying the content element; and
for at least one content element, updating information identifying user identities of participants whose participant devices are displaying the content element.

13. The method of claim 12, further comprising, with at least the first participant device: displaying, for at least one content element of the collaboration session, a visual indicator that identifies a number of participant devices displaying the content element, as identified by the context information.

14. The method of claim 12, further comprising, with at least the first participant device: displaying, for at least one content element of the collaboration session, a visual indicator that identifies user identities of participants of participant devices displaying the content element, as identified by the context information.

15. The method of claim 1, further comprising: with at least a first participant device that receives the content and the context information from the collaboration system,
responsive to reception of user input identifying a focus view mode, displaying a first content element of the collaboration session that has a current focus, as indicated by the relevancy ordering; and
responsive to receiving the updated context information that includes an updated relevancy ordering that identifies a second content element as the content element that has the current focus, displaying the second content element.

16. The method of claim 1, further comprising: with at least a first participant device that receives the content and the context information from the collaboration system,
responsive to reception of user input identifying a focus view mode with follow mode disabled, displaying a first content element of the collaboration session; and
maintaining display of the first content element responsive to receiving the updated context information that includes an updated relevancy ordering that identifies a second content element as the content element that has a current focus.

17. A collaboration system comprising:
at least one processor; and
at least one storage medium coupled to the at least one processor, the at least one storage medium storing machine-executable instructions that, when executed by the at least one processor, control the collaboration system to:
establish a collaboration session with a plurality of participant devices via at least one network;
receive at least one content stream from at least two of the plurality of participant devices, the received content streams including at least one video stream and at least three screen share streams;
add the received content streams to the collaboration session as content of the collaboration session;
generate context information for the collaboration session, wherein generating context information comprises: generating a relevancy ordering of all content streams of the collaboration session according to relevance;
provide the content of the collaboration session to each of the plurality of participant devices;
provide at least a portion of the context information to each of the plurality of participant devices;
receive participant context information from at least one participant device;
update the context information for the collaboration session based on the received participant context information, wherein updating the context information comprises: updating the relevancy ordering of the context information; and
provide at least the updated relevancy ordering of the updated context information to each of the plurality of participant devices.

18. The system of claim 17, wherein the collaboration system is constructed to update display of the content of the collaboration session at a display system coupled to the collaboration system, based on the updated relevancy ordering.

19. The system of claim 17, wherein the collaboration system is constructed to update the relevancy ordering in accordance with a number of participant devices displaying each content element, as identified by the received participant context information.

20. The system of claim 17, wherein the collaboration system is constructed to update the relevancy ordering based on in response to at least one of selection of at least one content element, annotation of at least one content element, addition of participant sentiment data for at least one content element, and addition of participant reaction data for at least one content element, as identified by the received participant context information.
